(19) United States
(12) Patent Application Publication
(10) Pub. No.: US 2004/0020316 A1
(43) Pub. Date: Feb. 5, 2004

(54) Furniture drive embodied as a double drive

(76) Inventor: Eckhardt Dewert, Zurich (CH)

Correspondence Address: Robert W Becker & Associates, Suite B, 707 Highway 66 East, Tijeras, NM, 87059, US

(21) Appl. No.: 10/381,396

(22) PCT Filed: Aug. 3, 2001
(86) PCT No.: PCT/EP01/09000

(30) Foreign Application Priority Data
Sep. 21, 2000 (DE) 100467504

(51) Int. Cl. F16H 25/20

(52) U.S. Cl. 74/89.23

(57) ABSTRACT

A dual power unit for movement of a back and a footrest in a power-driven armchair comprises an elongated casing (11) which, close to each end, has a transverse-movement shaft (12) which is connected to a shaft (13) of an electric motor reducer through a transmission-gear (15). The transmission-gear comprises a screw (16) connected to the shaft (13) of the motor reducer and extended transversely of the movement shaft (12) and longitudinally of the casing and a threaded sliding slider (17) into which the screw is screwed down. The cam means is integral with the movement shaft and bears on the slider to convert the sliding motion of the slider along the screw into an angular-rotation movement of the movement shaft. The screw (16) thoroughly crosses the slider (17), and the cam means comprises two cam elements (19, 20) laterally projecting from the movement shaft for resting on thrust surfaces (21, 22) provided on the slider on opposite sides of the screw. The contact points between the cams and slider surfaces are disposed on a line meeting the screw axis.

The invention relates to a furniture drive, embodied as a double drive, of the type mentioned in the introductory portion of claim 1 for moving parts of a piece of furniture relative to one another.

Such furniture drives are known in general and serve, for example, as adjustment drives for the movement or adjustment of parts of a lattice structure relative to one another.

EP 0 372 032 B1 discloses a furniture drive, embodied as a double drive, for the adjustment of parts of a piece of furniture relative to one another, and is provided with two drive units. Each drive unit of the known furniture drive cooperates with a pivot lever that in the assembled position of the furniture drive is in functional connection with a part of the piece of furniture that is to be adjusted. With the known furniture drive, each drive unit has a linearly movable drive element that is in functional connection with the pivot lever for pivoting the latter. In this connection, the pivot lever is embodied as an angle lever upon which the linearly movable drive element, which is formed by a spindle nut that is disposed on an adjusting spindle, exerts pressure for pivoting the pivot lever and is thus in functional connection with the pivot lever.

DE 38 48 078 C2 discloses a similar furniture drive according to which each drive unit also cooperates with a pivot lever. With the furniture drive known from this document, the linearly movable drive element is formed by a spindle nut that is connected with a holding leg, of a right-angled push member, that extends parallel to the spindle axis, whereby the other pressing leg, which is perpendicular to the spindle axis, loosely acts upon the free end of the pivot lever and is thus in functional connection with the pivot lever.

EP 0 583 660 B1 discloses a furniture drive, embodied as a double drive, of the type in question for adjusting parts of a piece of furniture relative to one another, and has two drive units. Each drive unit of this furniture drive has a linearly movable drive element in the form of a spindle nut that serves for the pivoting of a pivot lever that, in the assembled position of the furniture drive, is in functional connection with a part of the piece of furniture that is to be adjusted. On that end that faces the pivot lever, the spindle nut is provided with a slot that extends perpendicular to the spindle axis and in which the pivot lever engages, and is tightly guided, via a pin disposed at the end of the pivot lever and extending essentially parallel to the pivot axis of the pivot lever. A drawback of this known furniture drive is that it has a complicated and expensive construction. Furthermore, with this known furniture drive non-symmetrical stressing of the pivot lever occurs since the point of force engagement of the drive element is disposed beyond the longitudinal central plane of the pivot lever.

The object of the invention is to provide a furniture drive, embodied as a double drive, of the type mentioned in the introductory portion of claim 1 that is simple in construction and hence economical to manufacture, and is also sturdy.

This object is realized by the teaching of claim 1.

According to the teaching of claim 1, the linearly movable drive element, or an actuating element connected therewith, is provided with a recess into which the pivot lever, which as a rule is not part of the furniture drive, but rather of a piece of furniture, for example a lattice structure, projects in the assembled position, whereby an inner wall of the recess forms an abutment surface for the pivot lever.

In this way there results a straightforward and hence more economical construction of the inventive furniture drive with relatively few components.

A particular advantage of the inventive furniture drive is that the pivot lever can be made shorter than is the case with the known furniture drives. In this way, the inventive furniture drive can be designed with a relatively low overall height. This has the significant advantage that when combining, for example, a lattice structure with an inventive furniture drive, the thus-formed unit has an overall height that is not, or is only slightly, greater than the overall height of the lattice structure itself.

A further advantage of the inventive furniture drive is that it has a sturdy construction and is suitable for the application of great forces.

A further advantage is that with the inventive furniture drive, the point of application of force of the actuating element against the pivot lever can be disposed in the longitudinal plane of the pivot lever, thus avoiding an non-symmetrical stressing of the pivot lever.

The inventive furniture drive is embodied as a dual or double drive. While basically maintaining the inventive principle of operation, it is, however, also possible to embody the furniture drive as a single drive.

An extremely advantageous further development of the inventive teaching provides for at least one slot in the abutment surface for receiving the lever arm of the pivot lever in at least one end position of the adjustment movement, and that the pivot lever, at a distance from the slot, rests against the abutment surface via an abutment member. With this embodiment, the free end of the pivot lever can extend deeply into the recess, so that the furniture drive has a particularly low overall height. While the pivot lever rests against the abutment surface via the abutment member, an undesired butting of the lever arm of the pivot lever against the abutment surface remote from the abutment member is avoided since this member of the pivot lever can be received in the slot. Thus, this embodiment enables a large pivot angle of the pivot lever accompanied by a simultaneous very compact construction.

A further development of the aforementioned embodiment provides that the abutment member extends essentially parallel to the pivot axis of the pivot lever. With this embodiment, the abutment member thus extends transverse to the slots, whereby a reliable contact against the abutment surface is ensured.

Another extremely advantageous further development provides that the pivot lever be embodied in a fork-shaped manner with two spaced-apart lever arms that extend parallel to one another, and that the abutment lever be held between the abutment arms of the pivot lever. This embodiment also enables a large pivot angle of the pivot lever with a simultaneously compact construction. Due to the lever arms that are spaced from one another, a symmetrical introduction of force, relative to the central longitudinal plane of the pivot lever, from the drive element or the actuating element into the pivot lever is facilitated. Non-symmetrical stressing of the pivot lever, which can lead to deformation and possibly damage thereto, is thereby avoided.

A further development of the aforementioned embodiment provides that the abutment surface is formed on a projection, whereby the inside width between the lever arms of the pivot lever essentially corresponds to or is greater than the dimension of the projection in this direction. With this embodiment, during the adjustment movement the abutment member of the pivot lever rests against the abutment surface, while the lever arms move laterally along the projection.

Another further development of the embodiment having the fork-shaped pivot lever provides that in the abutment surface, or in the region of the abutment surface, there are formed two slots that are spaced apart parallel to the pivot axis of the pivot lever and that extend essentially perpendicular to the pivot axis of the pivot lever, the slots being provided for receiving the spaced-apart lever arms of the pivot lever in an end position of the adjustment movement. With this embodiment, the stability of the components in which the recess is formed is improved relative to the aforementioned embodiment.

In principle, with the embodiment having the slot it is adequate if only at least one slot is formed in the abutment surface. However, pursuant to an expedient further development, one or more slots are formed in an inner wall of the recess that is remote from the abutment surface, whereby each lever arm of the pivot lever is associated with a slot for receiving the lever arm in at least one end position of the adjustment movement. In this way, a butting of the lever arm of the pivot lever against that inner wall of the recess that is opposite the abutment surface is prevented, so that the pivot angle of the pivot lever that can be achieved is increased even further.

With the embodiments having the slot or the slots, the open width of each slot expediently corresponds essentially to the dimension of the associated lever arm parallel to the pivot axis of the pivot lever, or is somewhat greater than this dimension. With this embodiment, the stability of the drive element or of the actuating element is adversely affected by the slots only to the extent that this is necessary due to the width of the lever arm, which can be kept small.

The shape and size of the abutment member can be selected over wide ranges. The abutment member can, for example, be plate-shaped or rod-shaped. One advantageous further development provides that the abutment member be formed by a roller that is preferably rotatably mounted on the free end of the pivot lever. In this embodiment, the friction of the abutment member against the abutment surface is reduced, so that power loss due to friction, as well as a wearing-away of the abutment surface, are avoided.

The shape of the drive element or of the actuating element is selectable over wide ranges. One advantageous further development provides that the drive element or the actuating element be open on one side relative to a side that in the assembled position faces the pivot lever. In this embodiment, the drive element or actuating element are embodied in the manner of a housing and are open only toward the pivot lever, otherwise however being closed. In this way a high stability is achieved.

In principle, the abutment surface can extend essentially perpendicular to the linear movement axis of the drive element. However, the abutment surface is expediently inclined relative to the linear movement axis of the drive element. In this way the pivot angle of the pivot lever that can be achieved is increased.

With the aforementioned embodiment, the abutment surface can be an essentially planar surface that is preferably inclined at an acute angle relative to the linear movement axis of the drive element. However, the abutment surface can also, at least in sections, have a curved cross-sectional configuration, whereby preferably an imaginary connecting line between end points of the curved cross-section of the abutment surface is inclined at an acute angle relative to the linear movement axis of the drive element. In this embodiment, particularly favorable conditions result with respect to the articulation angle of the pivot lever against the abutment surface.

A further development of the embodiment having the abutment surface with the curved cross-section is that the abutment surface have a concave cross section relative to the pivot lever.

Pursuant to another advantageous further development, the open width between the abutment surface and an oppositely disposed inner wall of the recess is greater than the dimension of the pivot lever or of the abutment member between the abutment surface and the opposite inner wall. This prevents a wedging or seizing of the pivot lever or of the abutment member in the recess.

The component in which the recess if formed can be made of any desired suitable material. The component is expediently made of polymeric material, as provided by a further development. In this embodiment, the manufacture of the inventive furniture drive is further simplified and hence more economical, since the drive element or the actuating element can be a simple and economical molded plastic part.

The linearly movable drive element can have any desired suitable configuration. One expedient further development provides that the linearly movable drive element be a spindle nut that is held on a rotatable adjusting spindle in a manner protected against torsion and movable in an axial direction. Such spindle drives are available as simple and economical standard components, thus further simplifying the manufacture of the furniture drive and hence providing an economical design. Since the spindle nut is generally a molded plastic part, the recess can be formed therein during the manufacture of the spindle nut.

In a kinematic reversal of the aforementioned embodiment, the linearly movable drive element can, however, also be an adjusting spindle that is mounted so as to be protected against torsion and movable in its axial direction, with a stationary, rotatable spindle nut being disposed on the adjusting spindle.

Another further development of the inventive teaching provides that in the assembled position of the furniture drive the pivot lever is fixedly connected with a rotatably mounted shaft that is in functional connection with a part of the piece of furniture that is to be moved or adjusted. In this connection, the pivot lever is generally not part of the furniture drive, but rather of an adjustment fitting, for example on a lattice structure. The pivot lever can, however, also be part of the furniture drive.

Pursuant to other expedient further developments, each drive unit is provided with an electric motor, and/or the drive units of the double drive are accommodated in a common housing.

The invention will be subsequently explained in greater detail with the aid of the accompanying schematic drawings in which an embodiment is illustrated.

Shown are:

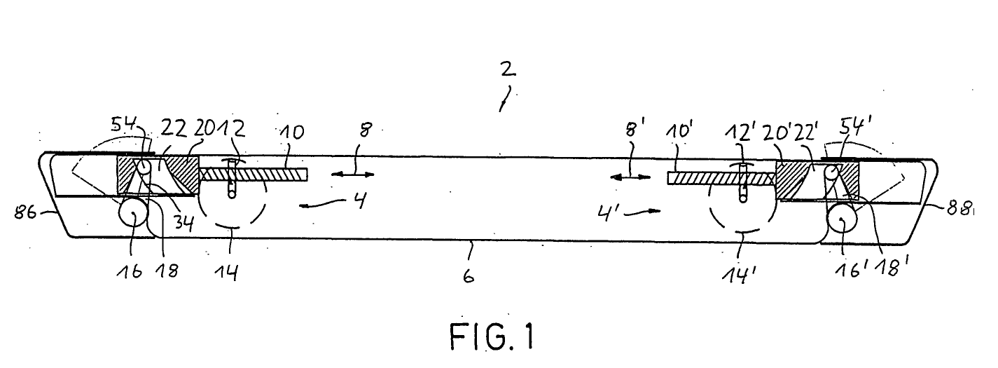

FIG. 1 in a very schematic side view, one embodiment of an inventive furniture drive, whereby for reasons of illustration a portion of the housing in which the drive units are accommodated is omitted,

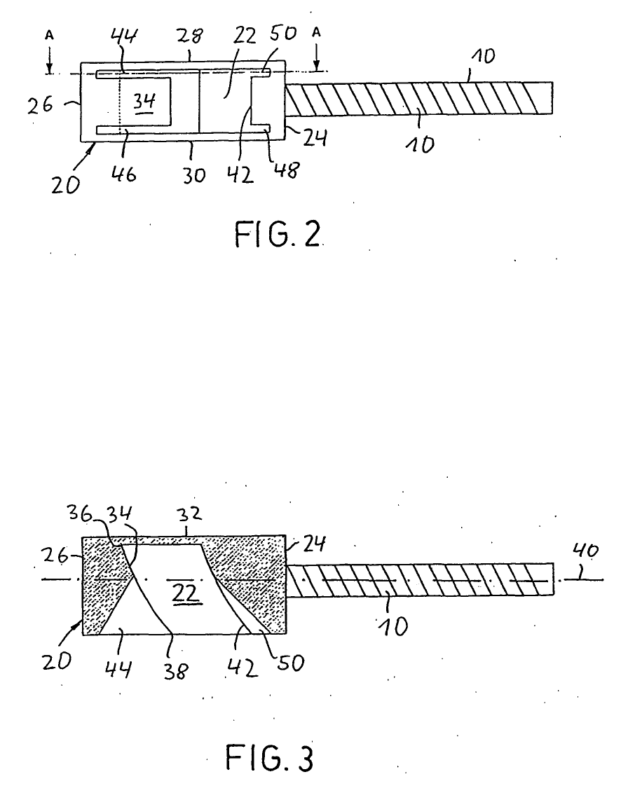

FIG. 2 a view from below in FIG. 1 onto an actuating element of a drive unit of the embodiment of FIG. 1,

FIG. 3 a cross-sectional view taken along the line A-A in FIG. 2,

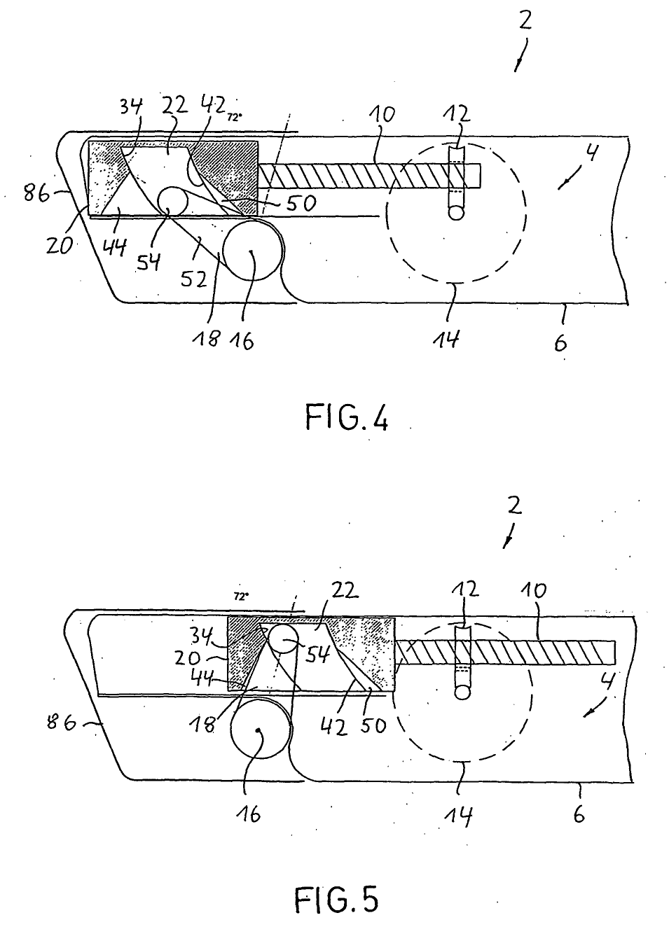

FIG. 4 in the same illustration, enlarged relative to FIG. 1, a drive unit of the furniture drive of FIG. 1 in a first adjustment position,

FIG. 5 in the same illustration as FIG. 4, the drive unit of FIG. 4 in a second adjustment position,

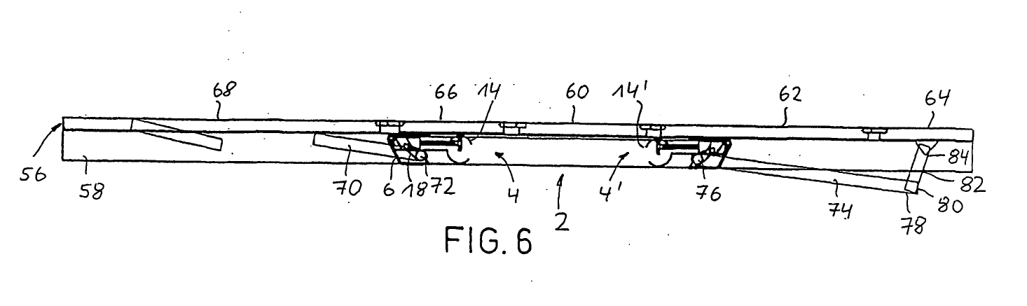

FIG. 6 in a very schematic side view, an embodiment of a support device for a cushion of furniture for sitting and/or resting in the form of a lattice structure that is provided with a furniture drive according to FIG. 1 in a first adjustment position,

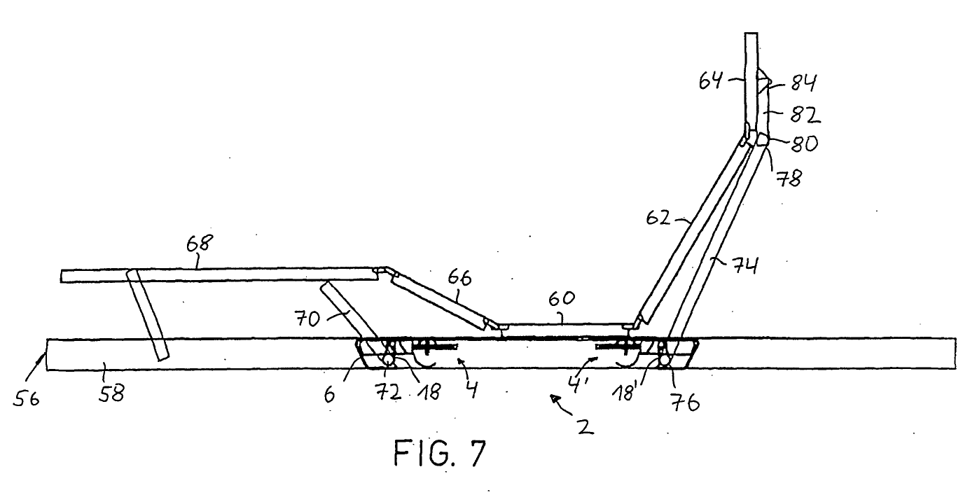

FIG. 7 the support device of FIG. 6 in a second adjustment position,

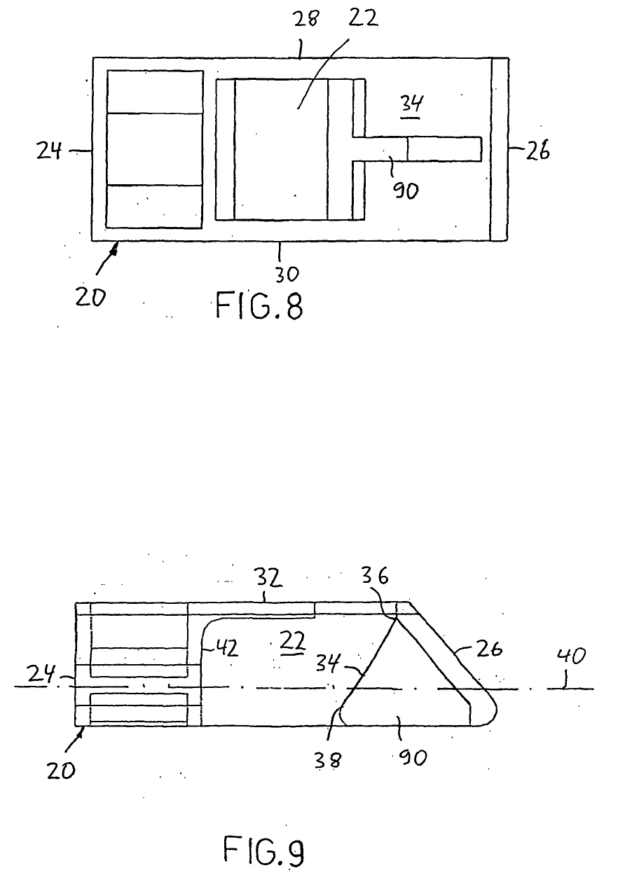

FIG. 8 in a view similar to FIG. 2, an actuating element of a second embodiment of an inventive furniture drive, and

FIG. 9 in a view similar to FIG. 3, the actuating element of FIG. 8.

FIG. 1 illustrates one embodiment of an inventive furniture drive 2, which in this embodiment is embodied has a double drive and as two drive units 4, 4′ that are accommodated in a common housing 6 and are held thereon by non-illustrated fastening means. Only the drive unit 4 will be explained in greater detail subsequently. The drive unit 4′ is correspondingly constructed, and its components are provided with reference symbols that correspond to the reference symbols of the components of the drive unit 4.

The drive unit 4 has a linearly movable drive element, which in this embodiment is formed by an adjusting spindle 10 that is movable back and forth in its axial direction in the direction of a double arrow 8, and which in this embodiment is embodied as a threaded spindle. Disposed upon the adjusting spindle 10, which is mounted in such a way as to be protected against torsion, as will be explained further subsequently, is a stationary spindle nut 12 that is provided with an internal thread and which, by means of an electric motor 14 that is indicated only schematically in the drawing, is rotatable via a non-illustrated gear mechanism. The drive units 4,4′ can be controlled together or separately from one another by means of control means that are not illustrated in the drawing. Similarly non-illustrated power supply means are provided for supplying power to the drive units 4,4′.

In the assembled position of the furniture drive 2, the adjusting spindle 14 is functionally connected with a pivot lever 18, which is pivotably mounted about a pivot axis 16, for the pivoting of the pivot lever. In this embodiment, the pivot lever 18 is not part of the furniture drive 2, but rather is part of an adjustment fitting of a support device, not illustrated in FIG. 1, for supporting a cushion of furniture for sitting and/or resting, for example of a lattice structure or grating.

For the pivoting of the pivot lever 18, the drive unit 4 is provided with an actuating element 20 that is connected with that end of the adjusting spindle 10 that faces the pivot lever 18, whereby the connection between the adjusting spindle 10 and the actuating element 20 is able to withstand pushing and pulling.

In this embodiment, the actuating element 20 is made of polymeric material and is embodied in the manner of a housing and is open on one side toward the pivot lever 18. It is provided with a recess 22 into which the pivot lever 18 extends in its radial direction, as can be seen from FIG. 1. To clarify the manner in which the inventive furniture drive functions, the actuating element 20 is shown sectioned in the side view of FIG. 1.

FIG. 2 shows a view from below in FIG. 1 onto the actuating element 20 of FIG. 1, whereby it can be seen that the actuating element 20 is closed on its narrow side 24, which faces the adjusting spindle 10, as well as on its opposite narrow side 26, as well as on its long sides 28, 30. From FIG. 3, which is a cross-sectional view taken along a line A-A in FIG. 2, it can be seen that the actuating element 20 is also closed on its upper side 32. In this way, the actuating element 20 is particularly stable.

By means of an inner wall of the recess 22, and abutment surface 34 is formed for the free end of the pivot lever 18, which is not illustrated in FIG. 3, the abutment surface having a curved or arcuate cross-section and extending concavely relative to the pivot lever 18. An imaginary connecting line between end points 36, 38 of the curved cross-section of the abutment surface 22 forms an acute angle with a linear movement axis of the adjusting spindle 10, which is indicated in FIG. 3 by a dot-dash line 40.

An inner wall 42 of the recess 22 that is disposed across from the abutment surface 34 is also curved and extends essentially parallel to the abutment surface 34.

In a direction parallel to the pivot axis 16, next to the abutment surface 34, the actuating element 20 is provided with slots 44, 46 that extend from the abutment surface 34 in the direction toward the end 26 of the actuating element 20, and extend essentially perpendicular to the pivot axis 16 of the pivot lever 18. In a corresponding manner, slots 48,50 extend from the wall 42 in the direction toward the narrow side 24 of the actuating element 20.

It cannot be seen from the drawing, and is therefore not explained here, that the pivot lever 18 in this embodiment has a fork-shaped configuration and is provided with two narrow lever arms that are parallel to one another and in a direction parallel to the pivot axis 16 are spaced from one another, with only one lever arm 52 being recognizable in the drawing. Between the lever arm 52 and the other lever arm, there is held on that end of the pivot lever that is remote from the pivot axis 16 an abutment member for engagement against the abutment surface 34, whereby in this embodiment the abutment member is formed by a roller that is mounted on the pivot lever 18 so as to be rotatable about an axis that is parallel to the pivot axis 16.

The movement or adjustment position of the drive unit 4 illustrated in FIG. 4 corresponds, in the embodiment, to a first end position in which the parts of the piece of furniture that is not illustrated in FIG. 2, which parts are movable by means of the furniture drive, are not moved relative to one another. In this end position, the roller 54 is not in engagement with the abutment surface 34, as can be seen from FIG. 4. The lever arm 52 of the pivot lever 18 extends into the slot 50, while the other lever arm that is not recognizable in the drawing extends into the slot 48.

To pivot the pivot lever 18, and hence to move a part of a piece of furniture that is functionally connected with the pivot lever 18, but is not illustrated in FIG. 4, the spindle nut 12 is rotatably driven by the electric motor 14 in such a way that the adjusting spindle 10 is moved to the right in FIG. 4 together with the actuating element 20. In the process, the roller 54 of the pivot lever 18 runs up upon the abutment surface 34, which during the further course of the adjustment movement lightly contacts the pivot lever 18 and exerts a traction force upon the pivot lever 18, due to which the pivot lever 18 is pivoted about its pivot axis 16 in a clockwise direction in FIG. 4.

During the further course of the adjustment movement, the roller 54 moves upwardly along the abutment surface 34 in FIG. 4, so that the pivot lever 18 is pivoted further about its pivot axis 16.

During the pivoting, the pivot lever 18 moves a part of a piece of furniture that is not illustrated in FIGS. 1 to 5, with the pivot lever 18 being in functional connection with the piece of furniture in a suitable manner.

FIG. 5 illustrates the other end position of the adjustment movement, which corresponds to a maximum adjustment or movement of the part of the non-illustrated piece of furniture that is to be moved. In this second end position of the adjustment movement, the lever arm 52 extends into the slot 44 and the other lever arm of the pivot lever 18 extends into the slot 46.

As can be seen from a comparison of FIGS. 4 and 5 the slots 44, 46 or 48, 50 prevent the pivot lever 18, in the region of the end positions of the adjustment movement, from butting against the walls of the recess 20 with that portion thereof that faces the pivot axis 16. Thus, the slots 44, 46 or 48, 50 make it possible for the pivot lever 18 to extend far into the recess 22 to the region of the upper wall of the actuating element 20, so that while at the same time having a large pivot angle of the pivot lever 18 between its end positions, in the embodiment approximately 72°, an extremely low overall height of the drive unit 4, and hence of the overall furniture drive 2, is made possible.

Since the abutment surface 34 has a curved cross section and is concave towards the roller 54, particularly favorable conditions result with regard to the angle that changes during the adjustment movement and at which the actuating element 20 engages against the pivot lever.

As can be seen from FIGS. 4 and 5, the inside width between the abutment surface 34 and the oppositely disposed wall 42 of the recess 22 is greater than the dimension of the roller 54 in this direction. This avoids a wedging or seizing of the roller 54 in the recess 22. Furthermore, in this way, if, with the influence of a user, a part of a piece of furniture that has been adjusted via the pivot lever 18 tries to move the pivot lever 18 that is in the second end position that is illustrated in FIG. 5 further in the clockwise direction, there is avoided that the roller comes to rest against the inner wall 42, thereby placing the actuating element under pressure.

FIG. 6 illustrates a support device, provided with the furniture drive 2, for supporting a cushion of a piece of furniture for sitting and/or resting, whereby in this embodiment the support device is formed by a lattice structure 56. The lattice structure 56 is provided with a frame 58 as well as a plurality of hingedly interconnected support elements. In detail, the lattice structure is provided with a central support element 60, with one side of which an upper body support element 62 is hingedly connected and is pivotable about a horizontal pivot axis, with that side of the upper body support that is remote from the central support element 60 a head support element 64 is pivotably connected and is pivotable about a horizontal pivot axis. A leg or thigh support element 66 is hingedly connected with that side of the central support element 60 that is remote from the upper body support element 62 and is pivotable about a horizontal pivot axis, and a calf support element 68 is hingedly connected with that side of the leg support element that is remote from the central support element 60 and is pivotable about a horizontal pivot axis.

To adjust or move the leg support element 66 and the calf support element 68 relative to the central support element 60, a pivotable adjustment lever 70 is provided that is fixedly connected with a pivot shaft 72 with which also the pivot lever 18 is fixedly connected. The adjustment lever 70 is thus pivotable together with the pivot lever 18 about the pivot axis 16 of the latter. The underside of the leg support element 68 rests loosely upon the adjustment lever 70.

To move or adjust the upper body support element 62 and the head support element 64 relative to the central support element 64, a further adjustment lever 74 is provided that is fixedly connected with a further pivot shaft 76 with which also the pivot lever 18′ that is associated with the drive unit 4′ is fixedly connected. The further adjustment lever 74 is pivotable together with the pivot lever 18′ about the pivot axis 16′ of the latter.

One end 80 of a link lever 82 is hingedly connected with that end 78 of the adjustment lever 74 that is remote from the pivot lever 18′, and the other end 84 of the link lever is hingedly connected with the head support element 64.

FIG. 6 shows the lattice structure 56 in a position in which the support elements 62, 64, 66, 68 are not moved relative to the central support element 60. To move or adjust the leg support 66 and the calf support element 68 relative to the central support element 60, the electric motor 14 drives the spindle nut 12 in such a way that the adjusting spindle 10, together with the actuating element, are moved toward the right in FIG. 6, so that the pivot lever 18 is taken along by the actuating element 20 and in so doing is pivoted in a clockwise direction in FIG. 6 about its pivot axis 16. In this connection, the adjustment lever 70 correspondingly also pivots in the clockwise direction and moves the calf support element 68, together with the leg support element 66, until the end position of the adjustment movement illustrated in FIG. 7 is achieved.

In a corresponding manner, for adjusting or moving the upper body support element 62 and the head support element 64 relative to the central support element 60, the electric motor 14′ of the drive unit 4′ drives the spindle nut 12′ in such a way that the adjusting spindle 10′, together with the actuating element 20′, are moved toward the left in FIG. 6. In so doing, the pivot lever 18′ is taken along by the actuating 20′ and is pivoted in the clockwise direction in FIG. 6 so that also the further adjustment lever 74 is pivoted and the upper body support element 62 and the head support element 64 are moved until the end position of the adjustment movement illustrated in FIG. 7 is achieved. For returning to the adjustment position illustrated in FIG. 6, the electric motor 14 drives the spindle nut 12 such that the adjusting spindle 10, together with the actuating element 20, are moved toward the left in FIG. 6. In so doing, the leg support element 66 and the calf support element 68 are returned under the effect of their weight. The return of the upper body support element 64 is effected in a corresponding manner.

The inventive furniture drive 2 is straightforward and economical in construction as well as sturdy. Due to the inventive configuration of the actuating elements 20 and 20′, the pivot levers 18, 18′ can be relatively short, so that a compact construction with a low overall height results.

As can be seen from FIGS. 6 and 7, due to this low overall height, the inventive furniture drive 2 does not project beyond the frame 28 of the lattice structure 56.

To mount the furniture drive 2 on the lattice structure 56, the housing 6 is placed, from above, onto the pivot shafts 72, 76 of the fitting of the lattice structure 56, and is secured with cap-shaped protection or retaining elements 86 and 88 (see FIG. 1) whereby the retaining element 86 in FIG. 1 is pressed upon the housing 6 from the left, and the retaining element 88 in FIG. 1 is pressed upon the housing 6 from the right.

The housing 6 can be made of polymeric material and, for absorbing the high forces that occur during operation of the furniture drive 2, can be provided with metal reinforcements.

Illustrated in FIG. 8 is an actuating element 20 of a second exemplary embodiment of an inventive furniture drive 2 that primarily differs from the actuating element of FIG. 2 in that in the region of the abutment surface 34 there is provided merely a single slot 90 that extends from the abutment surface 34 in a direction toward the end 26 of the actuating element 20, and extends essentially perpendicular to the pivot axis 16 of the pivot lever, which is not illustrated in FIG. 8. In this embodiment, in contrast to the embodiment illustrated in FIGS. 1 to 7, the pivot lever does not have a fork-shaped configuration, but rather has only a single lever arm. An abutment member, which is also not illustrated in FIG. 8, is disposed on the free end of the pivot lever and extends transverse to the slot 90 such that on both sides of the slot 90 the abutment member rests against the abutment surface 34.

Since only a single slot 90 is provided in the abutment surface 34, with this embodiment the stability of the actuating element is improved. In addition, the actuating element 20 is easier to produce.

FIG. 9 shows a longitudinal cross-sectional view through the actuating element 20 of FIG. 8 in the region of the slot 90. From FIG. 9, it can be seen that that wall 42 of the recess 22 that is remote from the abutment surface 34 extends, in this embodiment, perpendicular to the linear movement axis 40. In FIG. 8 and FIG. 9 the adjusting spindle is not illustrated, which is connected with that end 24 of the actuating element that is remote from the abutment surface 34 such that it can stand pushing and pulling.

1. Furniture drive embodied as a double drive for moving parts of a piece of furniture relative to one another, with two drive units, whereby each drive unit is provided with a linearly movable drive element for pivoting a pivot lever that in an assembled position of the furniture drive is in functional connection with a part of the piece of furniture that is to be adjusted, characterized in that,
the linearly movable drive element, or an actuating element (20) that is connected therewith, is provided with a recess (22) into which, in the assembled position of the furniture drive (2), the pivot lever (18) extends in its radial direction, and
an inner wall of the recess (22) forms an abutment surface (34) for the pivot lever (18).

2. Furniture drive according to claim 1, characterized in that, in the abutment surface (34), or in the region of the abutment surface, at least one slot (44, 46) is provided for receiving the lever arm (52) of the pivot lever (18) in one end position of the adjustment movement, and in that the pivot lever (18), at a distance from the slot (44, 46), rests against the abutment surface (34) via an abutment member.

3. Furniture drive according to claim 2, characterized in that, the abutment component extends essentially parallel to the pivot axis (16) of the pivot lever (18).

4. Furniture drive according to claim 1, characterized in that, the pivot lever (18) is fork-shaped and has two parallel and spaced-apart lever arms (52) and in that the abutment member is held between the lever arms (52) of the pivot lever (18).

5. Furniture drive according to claim 4, characterized in that, the abutment surface (34) is formed on a projection, whereby the open width between the lever arms (52) of the pivot lever (18) essentially corresponds to or is greater than the dimension of the projection in this direction.

6. Furniture drive according to claim 4, characterized in that, in the abutment surface (34) or in the region of the abutment surface (34), two slots are formed that are spaced apart parallel to the pivot axis (16) of the pivot lever (18) and that extend essentially perpendicular to the pivot axis (16) of the pivot lever (18), the slots being provided for receiving the spaced-apart lever arms (52) of the pivot lever (18) in one end position of the adjustment movement.

7. Furniture drive according to claim 1, characterized in that, an inner wall of the recess (22) that is remote from the abutment surface (34) a slot or plurality of slots (48, 50) are formed, whereby each lever arm (52) of the pivot lever (18) is associated with a slot (48, 50) for receiving the lever arm (52) in an end position of the adjustment movement.

8. Furniture drive according to claim 6 or 7, characterized in that, the open width of each slot (44, 46; 48, 50) essentially corresponds to or is somewhat greater than the dimension of the associated lever arm (52) in the direction parallel to the pivot axis (16) of the pivot lever (18).

9. Furniture drive according to claim 1, characterized in that, the abutment member is formed by a rotatably mounted roller (54) that is preferably disposed on the free end of the pivot lever (18).

10. Furniture drive according to claim 1, characterized in that, the drive element or the actuating element (20) is open on one side relative to a side thereof that in the assembled position faces the pivot lever (18).

11. Furniture drive according to claim 1, characterized in that, the abutment surface (34) is inclined relative to the linear movement axis (40) of the drive element.

12. Furniture drive according to claim 11, characterized in that, the abutment surface is essentially a planar surface.

13. Furniture drive according to claim 12, characterized in that, the abutment surface (34) is inclined relative to the linear movement axis (40) of the drive element at an acute angle.

14. Furniture drive according to claim 11, characterized in that, the abutment surface (34) has a curved cross-section at least in sections.

15. Furniture drive according to claim 14, characterized in that, an imaginary connecting line between end points (36, 38) of the curved cross-section of the abutment surface (34) is inclined relative to the linear movement axis (40) of the drive element at an acute angle.

16. Furniture drive according to claim 14, characterized in that, the abutment surface (34) is concave in cross section relative to the pivot lever (18).

17. Furniture drive according to claim 1, characterized in that, the open width between the abutment surface (34) and an oppositely disposed inner wall (42) of the recess (22) is greater than the dimension of the pivot lever (18) or of the abutment member between the abutment surface (34) and the oppositely disposed inner wall (42).

18. Furniture drive according to claim 1, characterized in that, the component in which the recess is formed is made of polymeric material.

19. Furniture drive according to claim 1, characterized in that, the linearly movable drive element is a spindle nut that is protected against torsion and is movable in the axial direction and is held upon a rotatably drivable adjusting spindle.

20. Furniture drive according to claim 1, characterized in that, the linearly movable drive element is an adjusting spindle (10) that is movable in its axial direction and is mounted in a manner to be protected against torsion, whereby a stationary, rotatably drivable spindle nut (12) is disposed on the adjusting spindle.

21. Furniture drive according to claim 1, characterized in that, in the assembled position of the furniture drive (2) the pivot lever (18) is fixedly connected with a rotatably mounted shaft that is in functional connection with a part of the piece of furniture that is to be adjusted.

22. Furniture drive according to claim 1, characterized in that, each drive unit (4, 4′) has an electric motor (14, 14′).

23. Furniture drive according to claim 1, characterized in that, the drive units (4, 4′) of the double drive are received in a common housing (6).
